(19) United States
(12) Patent Application Publication
(10) Pub. No.: US 2012/0017180 A1
(43) Pub. Date: Jan. 19, 2012

(54) METHOD FOR ADJUSTING THE BACKGROUND IMAGE ON A SCREEN

(75) Inventors: Dominic Flik, Ottobrunn (DE); Peter Respondek, Greisdorf (AT)

(73) Assignee: DEUTSCHE TELEKOM AG, BONN (DE)

(21) Appl. No.: 13/126,549

(22) PCT Filed: Oct. 28, 2009
(86) PCT No.: PCT/EP2009/064211

§ 371 Date: Jul. 25, 2011

(30) Foreign Application Priority Data
Oct. 31, 2008 (DE) 10 2008 054 113.3

(51) Int. Cl. G06F 3/048

(52) U.S. Cl. 715/838

(57) ABSTRACT

Method for filling the screen 2 of a mobile terminal 1 with a background image, which is at least temporarily present in a memory of the terminal 1, whereby a selection mode is present, in which several background images are imaged on the screen 2 as thumbnail-sized patterns 6 and are available for selection, whereby the screen 2 that is presented to the user in the selection mode has a first optically separated screen zone, the “selection zone” 4, whereby the user has the ability to select from among a number of patterns 6 that are imaged in the selection zone 4, whereby this selection leads directly to filling the entire screen background with the corresponding background image.

The invention relates to a method for filling the screen of a mobile electronic device, in particular a mobile telephone or an MP3 player, with a background image that is present in a memory of the device, whereby a selection mode is provided in the device in which several background images are imaged on the screen as thumbnail-sized patterns and are available for selection. The invention also relates to the mobile device itself.

Quite generally, it is known of computer screens to fill the latter in operation, in particular in a type of active “stand-by” operation, with a background image to thus break up the uniformity of a black or white screen. In front of such a background image, functional elements are arranged specifically in active “stand-by” operation, for example icons for invoking programs or menu windows for interaction with a program. To a certain extent, the background image fills the space that these functional elements leave free on the screen. Meanwhile, such background images are also known from small mobile devices, in particular from cell phones. In particular, it is also known that each one can generate its own background itself and can select at any time from a number of patterns stored on the device. In this case, the background images are stored in a standardized image format, such as TIF or DEG, and can thus be transferred at will between various devices via different data paths.

For selection of a background image, the user selects a special function in his device in most cases via several steps, which then makes possible the selection between various stored images based on small patterns, so-called “thumbnails.” In most cases, the user can first gain a good idea of the effect based on a preview. Altogether, the switching among various background images is not configured especially comfortably, however, such that the switching of the background images is not a day-to-day action of a user.

It is now the object of this invention to provide a method that is to be implemented with simple means and that gives the user of such a terminal a comfortable way to switch between various background images with few hand movements. Moreover, the object of the invention is to propose a device for implementing the method.

These objects are achieved by the method with the characterizing features of claim 1 and the device according to claim 10. Special embodiments are mentioned in the respective subclaims.

Accordingly, the basic idea that is essential to the invention is, on the one hand, that the screen that is presented to the user in the selection mode is optically divided in such a way that the selection in a first smaller screen zone, “selection zone” below, is made possible, while the remainder of the screen, “functional zone” below, maintains the conventional functionality and in this case presents in particular the surface of the above-mentioned active “stand-by” operation. In this case, another essential idea of the invention is that the user obtains a way to select from among the number of patterns imaged in the selection zone, whereby this selection leads directly and thus without additional intermediate steps to the new configuration of the especially complete background with the background image that corresponds to the pattern.

In this way, an especially comfortable way is provided to switch with a few quick hand movements and especially intuitively among various background images. Because of the easy implementation, the switching of background images produces a completely new attractiveness. Users use this feature to adapt the screens of their devices, which are in particular mobile telephones or music players, in particular MP3 players, to special circumstances, such as current situations or moods, by invoking constantly new background images This attractiveness can be further increased by additional features:

Even if it is possible to implement the functionality according to the invention by keystrokes, it is still especially advantageous when the device has a touch .sensitive screen (“Touch Screen”). Thus, functional screen surfaces can be produced as user interfaces (or “UIs”), which are especially intuitive and are thus simple to operate. The selection of a pattern in the selection mode can thus be carried out on such a touch screen in such a way that the desired pattern is selected by a touch, for example in the form of a quick tap with a finger or a stylus.

To make still other functionalities possible, however, in particular a switching of the patterns, by means of touch, it is especially advantageous when the contact is configured as a gesture that sweeps over the screen and pulls a pattern. To fill the screen with the background image, the user can “grab” the selected pattern with a touch and move it by a sweeping or pulling gesture from the selection zone into the functional zone. if it reaches the functional zone with the pattern that is designed as a thumbnail and it releases the pattern, the latter spreads over the entire background and forms the background. Thus, ending the contact produces the immediate filling of the background with the corresponding background image.

Also, the type of presentation of the pattern allows special configurations: For example, it is especially advantageous when the patterns are shown in a virtual perspective arrangement in the selection mode in such a way that one of the patterns is in the foreground relative to the other patterns and therefore has a specific visual dominance. The mode of operation can then be configured in such a way that each of the visible patterns can be selected directly. It can also be configured, however, in such a way that only the dominant or prominent pattern is “active,” in such a way that in this state, only the prominent pattern can be selected, in particular is movable by the gesture in the functional zone and thus is selected as a background image. The other visible but non-active patterns, however, can also be activated by a movement. It is especially advantageous when the perspective arrangement of the patterns corresponds to a so-called “cover flow.” In such a cover flow, graphic elements, originally the covers of record albums, are displayed in a virtual 3D environment in a series and can be scrolled through to a certain extent.

Accordingly, the patterns of elements arranged behind one another concealed in a stack or a ring can be visualized, whereby the stack or the ring can be scrolled through or rotated by a corresponding gesture in such a way that the pattern in the virtual foreground changes. The front pattern in each case is prominent to a certain extent. It can now be active in the sense that it is ready for selection. In another embodiment, the prominent pattern can already automatically be highlighted itself by the prominence of the background filling. The background filling then immediately switches during scrolling.

The arrangement in such a geometric figure has the advantage of saving space. Thus, a significantly larger number of patterns can be shown in a small space,

An especially attractive type of display is provided when the patterns shown in each case are surrounded by a frame whose side borders and whose upper border are more narrow than the lower border. Thus, the pattern is presented as a conventional Polaroid print and awakens positive associations in the user with this “Retro Look.” Moreover, this Polaroid format has the further advantage that the lower, wider frame can be provided with additional information, which through the frame that comprises the pattern is in clear reference to the latter.

To provide the user with the ability to be able to select from any number of background images, it is advantageous if a pool of such background images is stored at a central location, in particular in the Internet, and can be requested there for the user. As a result, at least some of the patterns that can be shown originate from a supply of background images; the user can thus expand his own holdings enormously. For the network operator, this procedure has the advantage that traffic is generated on his network. The exchange of background images can also be in a mode as was and also still is the case in the case of the ring tones. This can correspondingly be used commercially.

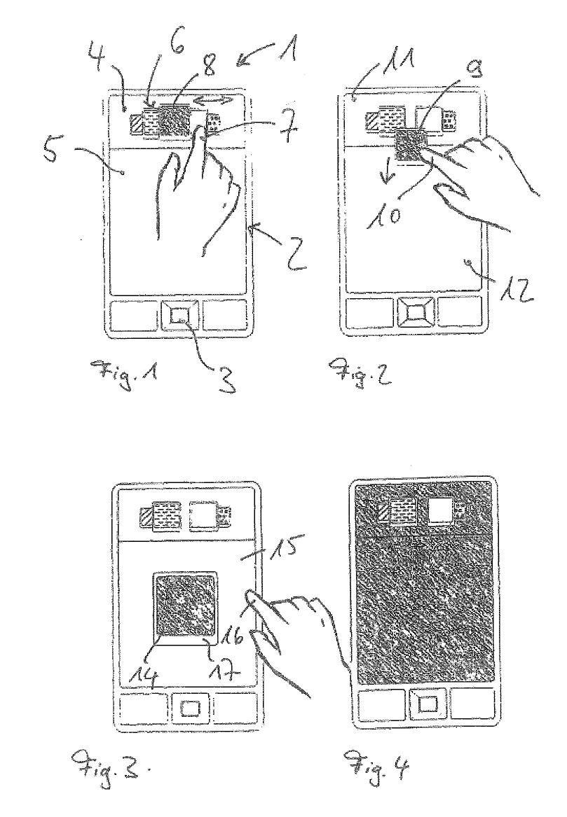

Below, the invention is explained in more detail based on FIGS. 1-4. The Figures show the sequence in the filling of the background with a background image.

FIG. 1 shows a mobile telephone I with a comparatively large touch-sensitive screen 2 (“Touch Screen”), which can be filled with a background image, whereby according to FIG. 1, the background is still uniformly white. The mobile telephone has a function key 3, which enables navigation within the menu, in particular the resetting into an initial state. In the imaged state, the mobile telephone 1 is in the selection mode according to the invention, in which the selection of various background images is possible.

In the selection mode, two optically separated screen zones 4 and 5 are presented to the user, whereby the zone 4 forms the smaller-sized “selection zone,” while the larger zone 5 remains as the “functional zone.” In this embodiment, on the screen 2, the selection zone 4 is arranged at the top, and the functional zone 5 is arranged at the bottom. Relative to the remaining functional zone 5, which contains operating elements that are necessary for operating the terminal but are not shown, the selection zone 4 is thus small.

In the selection zone 4, a number of five patterns 6 are shown here, which are symbolic in each case of a background image. The patterns 6 that are shown are shown as “Polaroids,” i.e., they have a frame 17 (FIG. 3), whose side borders and whose upper border are more narrow than the lower border. Moreover, they are arranged optically three-dimensionally in a “cover flow,” which can be scrolled with the finger 7 in a gesture performed in the direction of the arrow. In the state that is shown, the pattern 8 that is “at the top” in the cover flow is active and can be moved. The user thus has the ability to select a background from among the number of patterns 6 shown in the cover flow and thus to immediately fill the entire background of the screen 6 with the corresponding background image. This process is shown in the figures below:

In FIG. 2, the user “grabs” the active pattern 9 by touching it with a finger 10 and performs a gesture that sweeps over the screen and pulls the pattern 8 in the direction of the arrow, which runs from the selection zone 11 into the functional zone 12. In this case, the finger 10 remains on the pattern 9.

In FIG. 3, the user has guided the pattern 14 into the middle of the functional zone 15 and ends the gesture by lifting the finger 16. The pattern expands reciprocally and spreads over the entire screen. It can be seen from FIG. 4 how the pattern 14 has led immediately to filling the background with the background image, which the pattern 14 has shown.

1. Method for filling the screen (2) of a mobile terminal (1) with a background image, which is at least temporarily present in a memory of the terminal (1), whereby a selection mode is present, in which several background images are imaged on the screen (2) as thumbnail-sized patterns (6) and are available for selection, characterized in that the screen (2) that is presented to the user in the selection mode has a first optically separated screen zone, the “selection zone” (4), whereby the user has the ability to select from among a number of patterns (6) that are imaged in the selection zone (4), whereby this selection leads immediately to filling the entire screen background with the corresponding background image.

2. Method according to claim 1, wherein the rest of the screen, remaining in addition to the selection zone, the “functional zone” (5), maintains the normal functionality and presents in particular the surface of an active stand-by operation.

3. Method according to claim 1, wherein the selection by means of a contact of the imaged pattern (8) is carried out on the touch-sensitive screen, a so-called Touch Screen.

4. Method according to claim 3, wherein the contact is configured as a gesture that sweeps over the screen (2) and pulls a pattern, which leads from the selection zone (4) into the functional zone (5), whereby ending the contact produces the immediate filling of the background with the corresponding background image.

5. Method according to claim 1, wherein in the selection mode, the patterns (6) are shown in a perspective arrangement.

6. Method according to claim 5, wherein the pattern (8) in the foreground of the perspective arrangement is active in the sense that it is movable by a sweeping gesture in the functional zone (5).

7. Method according to claim 5, wherein the perspective arrangement corresponds to patterns (6) arranged behind one another concealed in a stack or a ring, which stack or ring is scrolled through or rotated by a corresponding gesture, in such a way that the pattern in the virtual foreground changes.

8. Method according to claim 1, wherein the patterns (6) that are shown have a frame (17), whose side borders and whose upper border are more narrow than the lower border.

9. Method according to claim 1, wherein at least some of the patterns (6) that are shown originate from a supply of background images, which is stored on a server that is accessible via a data line network, in particular the Internet.

10. Mobile electronic device, in particular a mobile telephone (1) or an MP3 player, and in particular for implementing the method according to claim 1, having a touch-sensitive screen (2), which can be filled with a background image that can be selected within a selection mode, whereby in the selection mode, at least some of the large number of background images are shown as thumbnail-sized patterns (6) on the screen (2) and can be selected by touch, wherein the screen (2) in the selection mode is configured in such a way that it has an optically recognizable first screen zone, the selection zone (4), on which a number of patterns (6) are shown, whereby the selection made by the user immediately leads to filling the entire screen background with the corresponding background image.

11. Electronic device according to claim 10, wherein the selection zone (4) relative to the remaining functional zone (5), which contains operating elements that are necessary for the operation of the device (1), is small.

12. Terminal according to claim 10, wherein on the screen (2), the selection zone (4) is arranged on the top, and the functional zone (5) is arranged on the bottom.
